(19) United States
(12) Patent Application Publication
(10) Pub. No.: US 2016/0163278 A1
(43) Pub. Date: Jun. 9, 2016

(54) SIGNAL ADJUSTMENT CIRCUIT

(71) Applicant: Pixtronix, Inc., San Diego, CA (US)

(72) Inventors: Ilias Pappas, Burlington, MA (US); Cait Ni Chleirigh, Burlington, MA (US)

(21) Appl. No.: 14/563,590

(22) Filed: Dec. 8, 2014

(51) Int. Cl. G09G 5/00

(52) U.S. Cl. CPC G09G 5/00

(57) ABSTRACT

This disclosure provides systems, methods and apparatus for adjusting a voltage applied to a transistor based on a change in an electrical characteristic. In one aspect, a system includes an array of display elements each including an electrical element having a first terminal and a transistor. Each electrical element is capable of at least a first and a second configuration based on an electrical state of the transistor. A current sensor is capable of sensing a current through at least one of the transistors. A compensation circuit compares the current with a reference current and provides at least one adjustment signal. A display driver provides an update voltage based on the at least one adjustment signal, and also provides a data signal for each of the display elements. The electrical state of each of the transistors is based on the update voltage and the data signal.

### TECHNICAL FIELD

This disclosure relates generally to devices incorporating transistor elements, and more particularly, to adjusting a voltage applied to a transistor based on a change in an electrical characteristic of the same or a different transistor.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

In some display devices, each display element of a display can include one or more transistors for performing an action with respect to the display element, such as changing a transmission state of the display element or otherwise driving the display element. Various irregularities, including dynamically-changing irregularities resulting from operation of the display (for example, resulting from electrically-induced stress), can cause variations or shifts in electrical characteristics such as the threshold voltages of the transistors throughout the display. In other words, the threshold voltages or other electrical characteristics of the transistors can deviate from their expected or theoretical values, and particularly, change on a dynamic basis during operation of the display. The extent of the irregularities also can be non-uniform across a display. As a result, the current flow through a transistor can deviate significantly from that which is expected, and for which a driving circuit and biasing conditions are designed. Such a deviation in current flow can, in the context of displays, result in incorrect or undesired display element states or have other adverse effects on the quality of displayed images.

### SUMMARY

The systems, methods and devices of this disclosure each have several innovative aspects, no single one of which is solely responsible for the desirable attributes disclosed herein.

One innovative aspect of the subject matter described in this disclosure can be implemented in a system that includes a display including at least an array of display elements. Each display element includes an electrical element having a first terminal and a first transistor electrically coupled with the first terminal. Each electrical element is capable of at least a first configuration and a second configuration based on an electrical state of the first transistor. The system also includes a first current sensor capable of sensing a first current through at least one of the first transistors in the array of display elements. The system also includes a compensation circuit capable of comparing the first current with a first reference current and providing at least one adjustment signal based on the comparison. The system further includes a display driver capable of providing an update voltage based on the at least one adjustment signal, and providing a data signal for each of the display elements. The electrical state of each of the first transistors is based on the update voltage and the data signal.

In some implementations, each electrical element includes a microelectromechanical systems (MEMS)-based light modulator. Each electrical element also can include at least one actuator electrically coupled with the first terminal and capable of causing the MEMS-based light modulator to transition among the first configuration and the second configuration.

In some implementations, the first current is equal to or proportional to a combined sum of the currents through the first transistors of the array of display elements. In some implementations, when the first current is greater than the first reference current, the compensation circuit provides a first value of the at least one adjustment signal configured to cause an increase in the update voltage. In some implementations, when the first current is approximately equal to the first reference current, the compensation circuit provides a second value of the at least one adjustment signal configured to cause the value of the update voltage to be maintained.

In some implementations, each electrical element further includes a second terminal and each display element further includes a second transistor electrically coupled with the second terminal. In some such implementations, the system further includes a second current sensor capable of sensing a second current through at least one of the second transistors, and the compensation circuit is further capable of comparing the second current with a second reference current and providing the at least one adjustment signal based on the comparison. In some implementations, when the second current is greater than the second reference current, the compensation circuit provides a third value of the at least one adjustment signal configured to cause a decrease in the voltage of the update voltage, and when the first current is approximately equal to the first reference current and the second current is approximately equal to the second reference current, the compensation circuit provides the second value of the at least one adjustment signal. In some implementations, when the first current is greater than the first reference current and the second current is greater than the second reference current, the compensation circuit provides a fourth value of the at least one adjustment signal configured to cause an indication of an error condition.

In some implementations, the system further includes a multiplier for multiplying the first reference current by a multiplication value to generate the second reference current. For example, the multiplication value can be proportional to a ratio of a capacitance of the first transistor to a capacitance of the second transistor. In some implementations, the second current is equal to or proportional to a combined sum of the currents through the second transistors of the array of display elements.

In some implementations, each electrical element further includes at least one actuator electrically coupled with the second terminal of the electrical element and capable of causing the electrical element to transition among the first configuration and the second configuration. In some implementations, the display driver is further capable of providing an enable voltage and the system further includes a plurality of enable lines each configured to communicate the enable voltage to the display elements. In some such implementations, each of the second transistors of the array of display elements includes a gate terminal electrically coupled with the first terminal of the electrical element, a second terminal electrically coupled with a corresponding one of the enable lines for receiving the enable voltage, and a third terminal electrically coupled with the second terminal of the electrical element.

In some implementations, the display driver is further capable of providing a write-enable signal, the system further includes a plurality of scan lines each configured to communicate the write-enable signal to a respective row of the display elements. The can further include a plurality of data lines each configured to communicate the data signal to a respective column of the display elements, and a plurality of update lines each configured to communicate the update voltage to the display elements. In some implementations, each of the first transistors includes a gate terminal electrically coupled with a corresponding one of the data lines for receiving the corresponding data signal, a second terminal electrically coupled with a corresponding one of the update lines for receiving the update voltage and a third terminal electrically coupled with the first terminal of the electrical element. In some implementations, the display driver is further capable of providing a pre-charge voltage and a supply voltage. The system can further include a plurality of pre-charge lines each configured to communicate the pre-charge voltage to the display elements, and a plurality of supply lines each configured to communicate the supply voltage to the display elements. Each display element can further include a third transistor having a gate terminal electrically coupled with a corresponding one of the pre-charge lines for receiving the pre-charge voltage, a second terminal electrically coupled with a corresponding one of the supply lines for receiving the supply voltage, and a third terminal electrically coupled with the first terminal of the electrical element. Each display element can further include a fourth transistor having a gate terminal electrically coupled with a corresponding one of the scan lines for receiving the write-enable signal, a second terminal electrically coupled with the corresponding one of the data lines for receiving the corresponding data signal, and a third terminal electrically coupled with the gate terminal of the first transistor for communicating the data signal to the gate terminal of the first transistor.

In some implementations, the system further includes a processor capable of communicating with the display and capable of processing image data. The system can further include a memory device capable of communicating with the processor, and a controller capable of sending at least a portion of the image data to the display driver. In some implementations, the controller sends the image data to the display driver in a series of image frames. Each image frame can include at least one bit-plane. In some implementations, the compensation circuit performs the comparing for each bit-plane in each image frame. In some implementations, the system further includes an image source module capable of sending the image data to the processor, and the image source module includes at least one of a receiver, transceiver, and transmitter. In some implementations, the system further includes an input device capable of receiving input data and communicating the input data to the processor.

Another innovative aspect of the subject matter described in this disclosure can be implemented in a display apparatus that includes a first transistor capable of receiving a data signal and an update voltage. An electrical state of the first transistor is based on the data signal and the update voltage. The display apparatus also includes an electrical element having a first terminal electrically coupled with the first transistor. The electrical element is capable of at least a first configuration and a second configuration based on the electrical state of the first transistor. The display apparatus further includes a first current sensor capable of sensing a first current through the first transistor. The display apparatus also includes a compensation circuit capable of comparing the first current with a first reference current and providing at least one adjustment signal based on the comparison. The display apparatus further includes a driver circuit capable of providing the update voltage for the first transistor based on the at least one adjustment signal.

In some implementations, when the first current is greater than the first reference current, the compensation circuit provides a first value of the at least one adjustment signal configured to cause an increase in the update voltage. In some implementations, when the first current is approximately equal to the first reference current, the compensation circuit provides a second value of the at least one adjustment signal configured to cause the value of the update voltage to be maintained.

In some implementations, the electrical element further includes a second terminal and the apparatus further includes a second transistor electrically coupled with the second terminal and a second current sensor capable of sensing a second current through the second transistor. In some such implementations, the compensation circuit is further capable of comparing the second current with a second reference current and providing the at least one adjustment signal based on the comparison. In some implementations, when the second current is greater than the second reference current, the compensation circuit provides a third value of the at least one adjustment signal configured to cause a decrease in the voltage of the update voltage, and when the first current is approximately equal to the first reference current and the second current is approximately equal to the second reference current, the compensation circuit provides the second value of the at least one adjustment signal. In some implementations, when the first current is greater than the first reference current and the second current is greater than the second reference current, the compensation circuit provides a fourth value of the at least one adjustment signal configured to cause an indication of an error condition.

In some implementations, the electrical element is capable of displaying light based on the first configuration and the second configuration.

Another innovative aspect of the subject matter described in this disclosure can be implemented in an apparatus that includes first switching means for receiving a data signal and an update voltage. An electrical state of the first switching means is based on the data signal and the update voltage. The apparatus also includes electrical means having a first terminal electrically coupled with the first switching means. The electrical means is capable of at least a first configuration and a second configuration based on the electrical state of the first switching means. The apparatus also includes first current sensing means for sensing a first current through the first switching means. The apparatus also includes compensation means for comparing the first current with a first reference current and providing at least one adjustment signal based on the comparison. The apparatus further includes driving means for providing the update voltage for the first switching means based on the at least one adjustment signal.

In some implementations, when the first current is greater than the first reference current, the compensation means provides a first value of the at least one adjustment signal configured to cause an increase in the update voltage, and when the first current is approximately equal to the first reference current, the compensation means provides a second value of the at least one adjustment signal configured to cause the value of the update voltage to be maintained.

In some implementations, the electrical means further includes a second terminal and the apparatus further includes second switching means electrically coupled with the second terminal of the electrical means, and second current sensing means for sensing a second current through the second switching means. In some implementations, the compensation means is further for comparing the second current with a second reference current and providing the at least one adjustment signal based on the comparison. In some implementations, when the second current is greater than the second reference current, the compensation means provides a third value of the at least one adjustment signal configured to cause a decrease in the voltage of the update voltage. In some implementations, when the first current is approximately equal to the first reference current and the second current is approximately equal to the second reference current, the compensation means provides the second value of the at least one adjustment signal. In some implementations, when the first current is greater than the first reference current and the second current is greater than the second reference current, the compensation means provides a fourth value of the at least one adjustment signal configured to cause an indication of an error condition.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 shows a schematic diagram of an example display element that includes five transistors.

FIG. 4 shows a timing diagram of an example sequence for loading and displaying data.

FIG. 5 shows a flowchart of an example process flow for loading and displaying data.

FIG. 6 shows a schematic diagram of an example compensation circuit.

FIG. 7 shows an example truth table that can be obtained using the example compensation circuit of FIG. 6.

FIG. 8A shows an example of a function generator.

FIG. 8B shows an example truth table that can be obtained using the example function generator of FIG. 8A.

FIG. 9 shows a flowchart of an example process flow for adjusting a voltage.

FIG. 10 shows a schematic diagram of an example display element that includes three transistors.

FIGS. 11A and 11B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. Some of the concepts and examples provided in this disclosure are especially applicable to electromechanical systems (EMS) and microelectromechanical (MEMS)-based displays such as the shutter-based displays described herein. However, some implementations also may be applicable to other types of displays, such as liquid crystal displays (LCDs), organic light-emitting diode (OLED) displays, and field emission displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Various implementations relate generally to a compensation circuit capable of dynamically tuning (also referred to herein as determining, changing, adjusting or updating) a voltage to be applied to a transistor. In some implementations, the tuned voltage is applied to each transistor of an array of transistors. The compensation circuit is capable of dynamically tuning the voltage during the operation of a device incorporating the transistor. For example, the device can be a display device and the transistor can be incorporated into a display element of a display. In some implementations, the compensation circuit tunes the voltage to be applied to the transistor responsive to a change in an electrical characteristic, such as a shift in a threshold voltage. For example, a threshold voltage shift can result from the operation of the device, and in some instances, can vary dynamically during operation of the device.

Particular implementations of the subject matter described in this disclosure can be implemented to realize one or more of the following potential advantages. Some implementations adjust a biasing voltage provided to a transistor to compensate for a shift in a threshold voltage of the transistor without actually detecting, determining or calculating the threshold voltage or threshold voltage shift. In other words, in some implementations, a value of the threshold voltage is not physically measured or actually calculated; instead, a compensation circuit can automatically update, or cause an update to, the voltage based on other detected or measured signals such as sensed current signals. Additionally, in some implementations, the biasing voltage can be adjusted based on one or more adjustment signals provided by logic devices without the use of a processor, microprocessor, complex logic or a lookup table. Additionally, the biasing voltage can be adjusted periodically or dynamically. For example, in display contexts, the biasing voltage can be adjusted during operation of a display with each update of image data. Some implementations also can be used to test a display or to detect a malfunction of the display by, for example, determining when a specific state of one or more of the signals described herein occurs. Such testing can be performed during the fabrication of the display as well as post-fabrication during operation of the display.

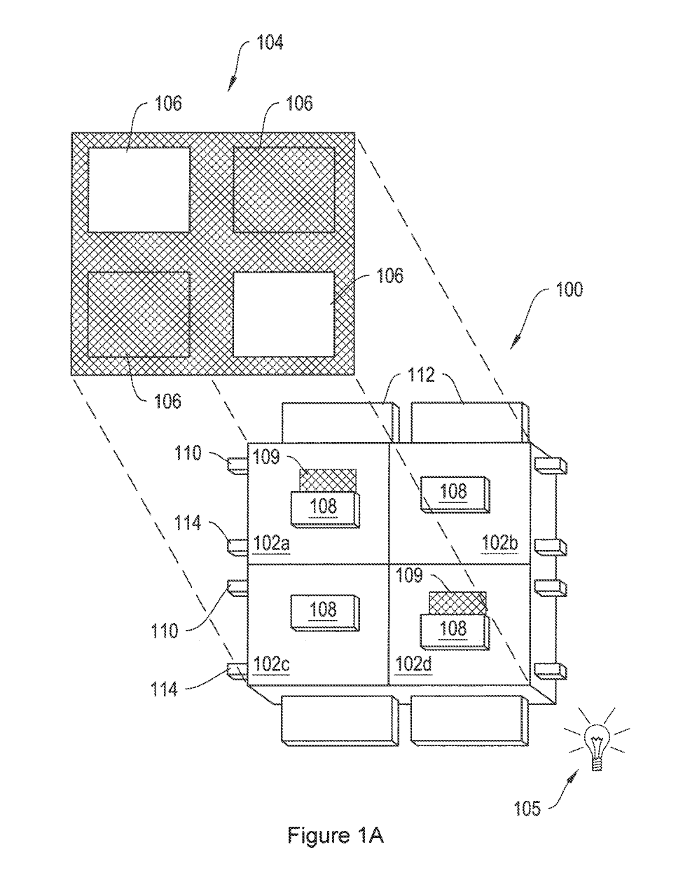

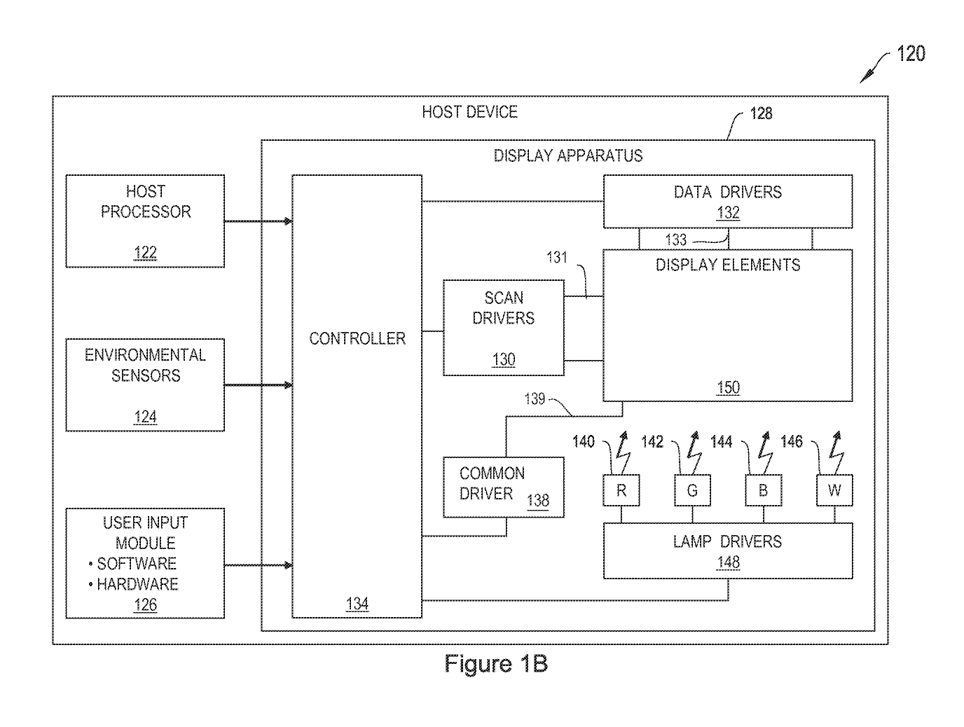

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state (also referred to herein as a configuration), a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed configurations, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

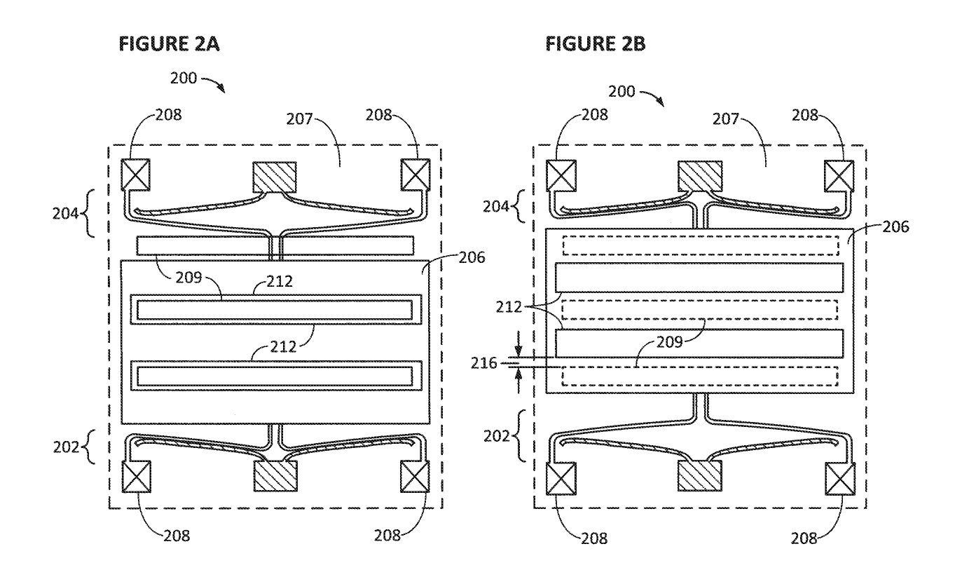

FIGS. 2A and 2B show views of an example dual actuator shutter assembly 200. The dual actuator shutter assembly 200, as depicted in FIG. 2A, is in an open configuration. FIG. 2B shows the dual actuator shutter assembly 200 in a closed configuration. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open configuration and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed configuration and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open configuration, the width or size of the shutter apertures 212 can be designed to be larger than a corresponding width or size of apertures 209 in the aperture layer 207. In order to effectively block light from escaping in the closed configuration, the light blocking portions of the shutter 206 can be designed to overlap the edges of the apertures 209. FIG. 2B shows an overlap 216, which in some implementations can be defined or predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed configuration (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

Electrical bi-stability in electrostatic actuators, such as actuators 202 and 204, can arise from the fact that the electrostatic force across an actuator is a function of position as well as voltage. The beams of the actuators in the shutter assembly 200 can be implemented to act as capacitor plates. The force between capacitor plates is proportional to 1/d² where d is the local separation distance between capacitor plates. When the actuator is in a closed configuration, the local separation between the actuator beams is very small. Thus, the application of a small voltage can result in a relatively strong force between the actuator beams of the actuator in the closed configuration. As a result, a relatively small voltage, such as Vₘ, can keep the actuator in the closed configuration, even if other elements exert an opposing force on the actuator.

In dual-actuator light modulators, the equilibrium position of the light modulator can be determined by the combined effect of the voltage differences across each of the actuators. In other words, the electrical potentials of the three terminals, namely, the shutter open drive beam, the shutter close drive beam, and the load beams, as well as modulator position, can be considered to determine the equilibrium forces on the modulator.

For an electrically bi-stable system, a set of logic rules can describe the stable configurations and can be used to develop reliable addressing or digital control schemes for a given light modulator. Referring to the shutter assembly 200 as an example, these logic rules are as follows:

Let Vₛ be the electrical potential on the shutter or load beam. Let Vₒ be the electrical potential on the shutter-open drive beam. Let V_{c} be the electrical potential on the shutter-close drive beam. Let the expression |Vₒ−Vₛ| refer to the absolute value of the voltage difference between the shutter and the shutter-open drive beam. Let Vₘ be the maintenance voltage. Let Vₐₜ be the actuation threshold voltage, i.e., the voltage to actuate an actuator absent the application of Vₘ to an opposing drive beam. Let Vₘₐₓ be the maximum allowable potential for Vₒ and V_{c}. Let Vₘ<Vₐₜ<Vₘₐₓ. Then, assuming Vₒ and V_{c} remain below Vₘₐₓ:

If |Vₒ−Vₛ|<Vₘ and |V_{c}−Vₛ|<Vₘ (rule 1)

Then the shutter will relax to the equilibrium position of its mechanical spring.

If |Vₒ−Vₛ|>Vₘ and |V_{c}−Vₛ|>Vₘ (rule 2)

Then the shutter will not move, i.e., it will hold in either the open or the closed configuration, whichever configuration was established by the last actuation event.

If |Vₒ−Vₛ|>Vₐₜ and |V_{c}−Vₛ|<Vₘ (rule 3)

Then the shutter will move into the open configuration.

If |Vₒ−Vₛ|<Vₘ and |V_{c}−Vₛ|>Vₐₜ (rule 4)

Then the shutter will move into the closed configuration.

Following rule 1, with voltage differences on each actuator near zero, the shutter will relax. In many shutter assemblies, the mechanically relaxed position is a partially open or partially closed configuration, and so this voltage condition is usually avoided in an addressing scheme.

The condition of rule 2 makes it possible to include a global actuation function into an addressing scheme. By maintaining a shutter voltage which provides beam voltage differences that are at least the maintenance voltage, Vₘ, the absolute values of the shutter open and shutter closed potentials can be altered or switched in the midst of an addressing sequence over wide voltage ranges (even where voltage differences exceed Vₐₜ) with no danger of unintentional shutter motion.

The conditions of rules 3 and 4 are those that are generally targeted during the addressing sequence to ensure the bi-stable actuation of the shutter.

The maintenance voltage difference, Vₘ, can be designed or expressed as a certain fraction of the actuation threshold voltage, Vₐₜ. For systems designed for a useful degree of bi-stability, the maintenance voltage can exist in a range between about 20% and about 80% of Vₐₜ. This helps ensure that charge leakage or parasitic voltage fluctuations in the system do not result in a deviation of a set holding voltage out of its maintenance range—a deviation which could result in the unintentional actuation of a shutter. In some systems, an exceptional degree of bi-stability or hysteresis can be provided, with Vₘ existing over a range of about 2% and about 98% of Vₐₜ. In these systems, however, care is taken to ensure that an electrode voltage condition of |V_{c}−Vₛ| or |Vₒ−Vₛ| being less than Vₘ can be reliably obtained within the addressing and actuation time available.

In some implementations, the first and second actuators of each light modulator are coupled to a latch or a drive circuit to ensure that the first and second configurations of the light modulator are the two stable states that the light modulator can assume.

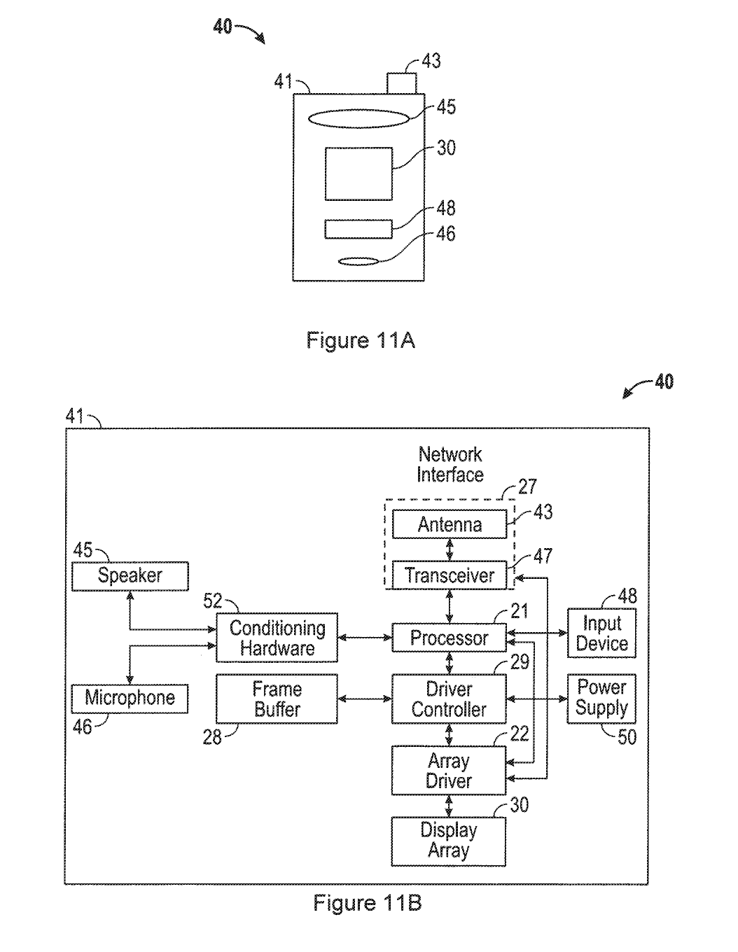

As described above, various implementations relate generally to a compensation circuit capable of dynamically tuning a voltage to be applied to a transistor. Some implementations describe a compensation circuit capable of dynamically tuning an update voltage V_{Upd} applied to a transistor of a display element during operation of a display. The display can include an array of display elements, each of which includes at least one transistor to which the update voltage V_{Upd} is applied. For example, the display can be the same or similar to the direct-view MEMS-based display apparatus 100 described with reference to FIG. 1A. In such implementations, each of the display elements includes a light modulator 102. As described above, each light modulator 102 can include a shutter assembly, such as the dual actuator shutter assembly 200 described with reference to FIGS. 2A and 2B. In some other implementations, the compensation circuit and other features described herein can be incorporated into any suitable display device using any suitable display technology such as, for example, the display device 40 and the display 30 described below with reference to FIGS. 11A and 11B. That is, the compensation circuits and other features described herein are not limited to any particular type of display element (nor to display elements in general). For example, in some other implementations, the compensation circuits can be used in conjunction with interferometric modulator (IMOD)-based display elements, liquid crystal display (LCD)-based display elements, light-emitting diode (LED)-based display elements or organic LED (OLED)-based display elements, among other suitable types of display elements or other electrical elements.

In some implementations, the active area of the display (for example, the portion of the display that displays an image) can include multiple arrays of display elements. For example, an active area of a display device can be manufactured to include two arrays: one for the top (or left) half of the display and one for the bottom (or right) half of the display. As another example, the active area of the display device can be manufactured to include four arrays: one for each of four quadrants of the display. In some implementations, each of the arrays of display elements is driven by a corresponding display driver. In some implementations, the display device also includes a compensation circuit for each of the arrays. In some such implementations, each display driver can include a compensation circuit. In some other implementations, the compensation circuit can be separate from, but electrically coupled with, the respective display driver.

In some implementations, some or all of the transistors described herein are thin-film transistors. A thin-film transistor (TFT) is a type of field-effect transistor (FET) formed by depositing one or more thin films of an active semiconductor layer, a dielectric layer and metallic (or otherwise conductive) contacts over a non-conductive substrate (such as a glass or plastic substrate). One difference between a TFT and a conventional FET, such as a conventional metal-oxide-semiconductor FET (MOSFET), is that in a conventional FET, the semiconductor material of the FET is an integral part of the substrate itself (for example, a die formed from a silicon wafer). Likewise, conventional FETs generally have four terminals (a gate terminal, a source terminal, a drain terminal and a bulk substrate terminal), while TFTs generally have three terminals (a gate terminal, a source terminal and a drain terminal, but no bulk substrate terminal). Additionally, no limitation is meant to be inherent or suggested by way of referring to the drain of any of the transistors described herein as a drain as opposed to a source, or by referring to the source of any of the transistors as a source as opposed to a drain. That is, the two terms—drain and source—are used interchangeably in this disclosure. For example, electrons may enter any of the transistors described herein by way of the drain and exit by way of the source, or vice versa, depending on the type of semiconducting material used in the transistor and on the voltages applied to the terminals of the transistor.

A threshold voltage shift can occur in each of some or all of the transistors in an array of display elements. The threshold voltage shift can result from, for example, electrically-induced stress arising during operation of the display. The impact of the electrically-induced stress on the threshold shifts also can be dependent on the material properties and geometrical characteristics of the transistors. In some implementations, some or all of the magnitude of the threshold shift arising during operation is reversible, that is, when the device is off the threshold voltage returns to normal. In other instances, some of the threshold voltage shift can be irreversible. The compensation circuit is capable of compensating for the threshold voltage shift whether the shift is reversible or irreversible.

A shift in the threshold voltage of a transistor from the expected value can result in undesirable deviations in the current flow through the transistor during operation. For example, the current flow through the transistor can deviate from that which is expected, and for which a driving circuit and biasing conditions are designed. Such a deviation in current flow can, in the context of displays, result in incorrect or undesired display element states (or state transitions) or have other adverse effects on the quality of displayed images.

In various display as well as non-display contexts, if the threshold voltage of a transistor is too low, the transistor can turn on (become conducting) too soon, or can turn on (at least partially) when it should be off (non-conducting). In some implementations, the resulting leakage current through the transistor can discharge (or conversely charge in some other implementations) a node of an electrical element that has at least a first configuration (also referred to herein as a state) and a second configuration. If the node of the electrical element is unintentionally discharged (or unintentionally charged), the electrical element can transition from one configuration to another configuration at an unsuitable or undesirable time, or conversely, not transition when it is intended to do so. On the other hand, if the threshold voltage is too high, the transistor may not turn on at all, turn on late, or otherwise not conduct enough current to enable the node to be discharged (or charged) at the intended or desired time.

In some display implementations, the electrical element can be a light modulator such as the light modulator 102 described with reference to FIG. 1A, or in some more specific implementations, a shutter-based element such as the dual actuator shutter assembly 200 described with reference to FIGS. 2A and 2B. For example, the node can be, or can be electrically connected to, a terminal of an actuator of the dual actuator shutter assembly 200. In some implementations, such unintended discharging (or charging) of the node and corresponding actuator can cause the shutter assembly to transition from the open configuration to the closed configuration, or vice versa, when it is not intended to do so. In some other implementations or applications, unintended discharging (or charging) of the node can prevent or inhibit the shutter assembly from transitioning when it is intended to do so, or to transition to an unintended intermediate (a partially open or partially closed configuration).

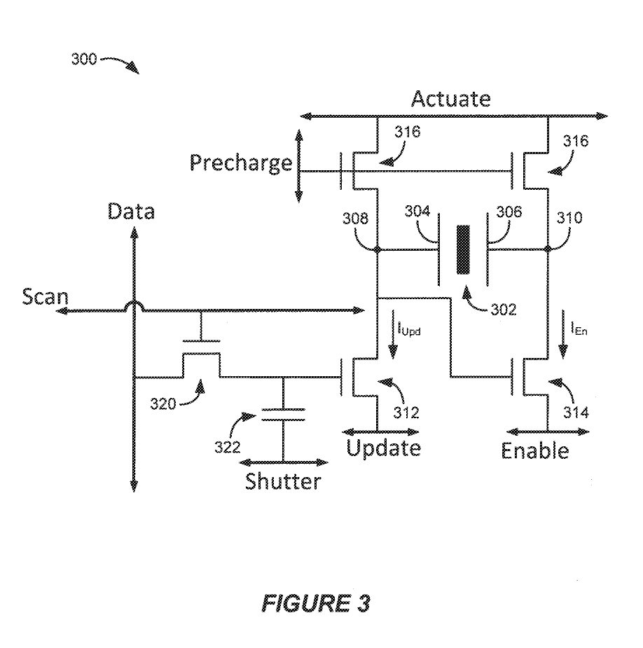

FIG. 3 shows a schematic diagram of an example display element 300 that includes five transistors. The display element 300 includes a light modulator 302 having a first terminal 304 and a second terminal 306. For example, the first terminal 304 can be connected with a first actuator of the light modulator 302 while the second terminal 306 can be electrically connected with a second actuator of the light modulator 302. The first terminal 304 is electrically connected to a first node 308 while the second terminal 306 is electrically connected to a second node 310. In some implementations, each of the first node 308 and the second node 310 can be an electrical interconnection, such as a conductive intersection of electrical traces, wires, interconnects or other links. The light modulator 302 is capable of a first configuration (for example, an open configuration in which the light modulator 302 allows light to pass to form an image) and a second configuration (for example, a closed configuration in which the light modulator 302 blocks light) responsive to a voltage between the first terminal 304 and the second terminal 306.

The display element 300 includes a first transistor 312 (also referred to as the update transistor) having a gate terminal (or gate), a drain terminal (or drain) and a source terminal (or source). The drain of the first transistor 312 is electrically connected to the first terminal 304 via the first node 308. The source of the first transistor 312 is electrically connected to an update line capable of carrying and providing an update voltage V_{Upd} to the source. In some implementations, a threshold voltage shift in the first transistor 312 can be especially undesirable because the first transistor 312 is responsible for discharging the first terminal 304, and thus, can directly have an impact on the connected actuator and the configuration of the light modulator 302.

The display element 300 also includes a second transistor 314 (also referred to as the enable transistor) having a gate, a drain and a source. The drain of the second transistor 314 is electrically connected to the second terminal 306 via the second node 310. The source of the second transistor 314 is electrically connected to an enable line capable of carrying and providing an enable voltage V_{En} to the source. The gate of the second transistor 314 is electrically connected to the first terminal 304 via the first node 308.

The display element 300 also includes a third transistor 316 (also referred to as the first pre-charge transistor) and a fourth transistor 318 (also referred to as the second pre-charge transistor). The drain of the third transistor 316 is electrically connected to the first terminal 304 via the first node 308 while the drain of the fourth transistor 318 is electrically connected to the second terminal 306 via the second node 310. The sources of the third and fourth transistors 316 and 318 are electrically connected to a supply (or actuate) line capable of carrying and providing a supply (or actuate) voltage V_{Act}. The gates of the third and fourth transistors 316 and 318 are electrically connected to a pre-charge line capable of carrying and providing a pre-charge voltage V_{Pre}.

The display element 300 further includes a fifth transistor 320 (also referred to as the data load transistor) and a capacitor 322. The source of the fifth transistor 320 is electrically connected to a corresponding data line (such as one of the data interconnects 112 or 133 described above) capable of carrying and providing a data signal V_{Data} for the display element. The gate of the fifth transistor 320 is electrically connected to a corresponding scan line (such as one of the write-enable interconnects 110 or 131 described above) capable of carrying and providing a scan (or write-enable) voltage V_{Scan} (also referred to as V_{WE} above in relation to FIG. 1A). The drain of the fifth transistor 320 is electrically connected to the gate of the first transistor 312 and to a terminal of the capacitor 322. The other terminal of the capacitor 322 is electrically connected to a reference line capable of carrying and providing a reference (or shutter) voltage V_{Shut}. In some implementations, although not shown for simplicity, the shutter voltage V_{Shut} is applied to a shutter element of the light modulator 302 (for example, the shutter 206 of the dual actuator shutter assembly 200).

As described above, the scan line can provide the scan voltage V_{Scan} to each display element 302 of an entire row of display elements of an entire array of display elements. Similarly, the data line can provide the data signal V_{Data} to each display element 302 of an entire column of display elements of an entire array of display elements. On the other hand, each of the update voltage V_{Upd}, the enable voltage V_{En}, the supply voltage V_{Act}, the pre-charge voltage V_{Pre} and the shutter voltage V_{Shut} can be global signals applied to the entire array of display elements substantially simultaneously.

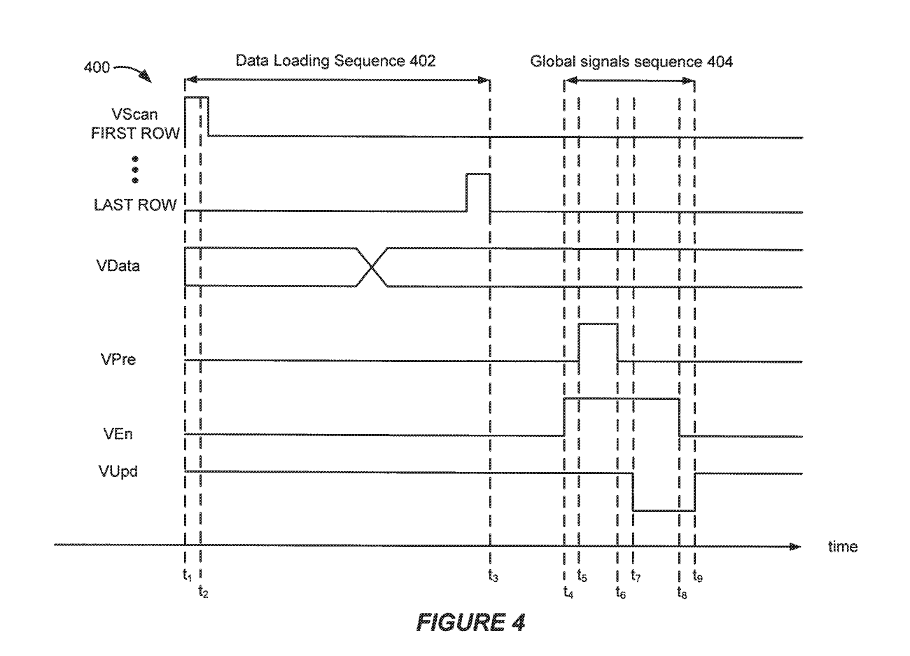

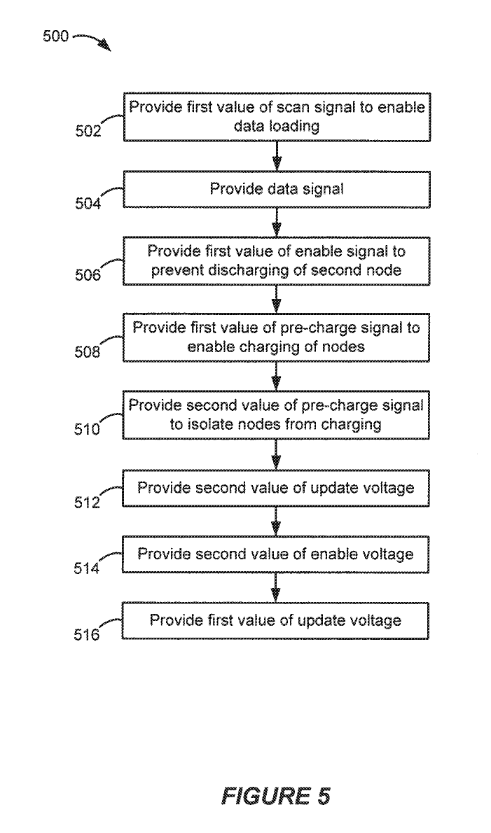

FIG. 4 shows a timing diagram of an example sequence 400 for loading and displaying data FIG. 5 shows a flowchart of an example process flow 500 for loading and displaying data. For example, the process flow 500 of FIG. 5 can be used to implement the sequence 400 of FIG. 4. In some implementations, the sequence 400 and process flow 500 are tailored or suitable for loading and displaying data in an active matrix display. For example, the sequence 400 and process flow 500 can be used to load and display data in a display that includes an array of display elements 300 as described with reference to FIG. 3.

In some implementations, the sequence 400 and the process flow 500 are tailored or suitable for loading and displaying data included in a bit plane of an image frame. In some such implementations, the sequence 400 and the process flow 500 are performed (or repeated) for each bit plane of each image frame. For example, a bit plane of image data can include a bit value for each display element 302 of the display (or array within the display). In some example implementations, each image frame includes 24 bit planes and thus can display 24-bit color depth images (or sequences of images such as a video). The color depth of a pixel generally increases (within the sensitivity of the human eye) with the number of bit planes per image frame. In some other implementations where less color depth is suitable or in which black and white (or grayscale) images are displayed, fewer bit planes can be suitable for each image frame. Additionally, a lower number of bit planes can be used for reduced-power modes.

In some implementations, each of the bit planes can be devoted to displaying a corresponding one of the three primary visible light colors: red, green and blue. In some more specific implementations, the light that is either passed or blocked by each of the light modulators 302 originates from red LEDs, green LEDs or blue LEDs provided through, or via, a backlight panel or substrate. For example, during the display of 8 of the 24 bit planes within a given image frame, the red LEDs are on and providing backlight illumination for the light modulators 302. Similarly, during the display of another 8 of the 24 bit planes within the image frame, the green LEDs are on and providing backlight illumination, and during the display of the remaining 8 of the 24 bit planes within the image frame, the blue LEDs are providing backlight illumination. In some implementations, all of the bit planes for a given color can be displayed sequentially before proceeding to the next color; for example, all of the red bit planes in an image frame can be displayed before displaying any green or blue bit planes in the same image frame. In some other implementations, the bit planes for the colors can be mixed or arranged intermittently; for example, a red bit plane can be followed by a green bit plane, which can be followed by a blue bit plane, before loading and displaying another red bit plane in the same image frame.

In some implementations, because each of the light modulators 302 is capable of and configured to display light of any color, time-division multiplexing (or modulation) techniques are used with the LEDs of different colors to achieve the desired perceived color of a display element 300 over the duration of an image frame. Again referring to the above 24-bit example, rather than one data loading period per image frame, there are 24 data loading periods during each image frame. In some implementations in which a shutter-based light modulator 302 is used, such a time-division modulation scheme can take advantage of the high switching speed of the shutters (for example, from open to closed and from closed to open). For example, it can be desirable for each of the light modulators 302 to be either entirely closed or entirely open. More specifically, it can be desirable for all of the light modulators 302 to be entirely closed in between LED illuminations, or desirable for a subset of the light modulators 302 to be entirely closed to display an image of reduced luminosity or to show a black image. Likewise, it can be desirable for all or a subset of the light modulators 302 to be entirely open during LED illumination. As described above, leakage current through one or both of the first and the second nodes 308 and 310, and more particularly through one or both of the first and the second transistors 312 and 314, can result in partial closure during a time when the light modulator 302 should be open, or partial opening when the light modulator 302 should be closed.

Such time-division modulation techniques as described above contrast with techniques used in other types of displays, such as LCDs, in which there are separate red, green and blue sub-pixels within a given pixel. In such other displays, a given bit plane or image frame can include image data for all of the different colored sub-pixels; that is, all backlight colors are provided simultaneously and filters are used to control which light is able to be passed through each of the sub-pixels.

Referring back to FIG. 4, in some implementations, the timing sequence 400 includes at least two sub-sequences: a data loading sequence 402 and a global signals (or display) sequence 404. In some implementations, the data loading sequence 402 proceeds sequentially row-by-row (and within each row, column-by-column) throughout the entire display (or array within the display). For example, in some implementations the data loading sequence 402 beings with the leftmost display element (for example, associated with the first column of display elements) of the topmost row (the first row of display elements). In some implementations, the display sequence 404 begins after the data loading sequence 402 has ended.

Referring now to FIG. 5 in conjunction with FIGS. 3 and 4, in some implementations the process flow 500 begins in block 502—time t₁—with the display driver providing a scan voltage V_{Scan} to the scan line connected with the first one of the display elements 300. In some implementations, the scan voltage V_{Scan} can have one of two values: a high value configured to enable data to be written (or loaded) into the display elements 300 of the associated row, and a low value that does not allow data to be loaded into the display elements 300. In the illustrated implementation, a high voltage value of the scan voltage V_{Scan} is provided in block 502 at time t₁. The high scan voltage V_{Scan} is applied to the gate of the data load transistor 320. Responsive to the high scan voltage V_{Scan}, the data load transistor 320 turns on. In block 504—time t₂—the display driver provides a data signal V_{Data} to the data line connected to the first display element 300. In some implementations, the data signal V_{Data} can have one of two values: a high value configured to cause the corresponding light modulator 302 to transition to an open configuration (or to remain in the open configuration) and a low value configured to cause the light modulator 302 to transition to the closed configuration (or to remain in the closed configuration). The data signal V_{Data} is applied to the source of the data load transistor 320. Because the data load transistor 320 is on, and because the drain of the data load transistor 320 is connected to the gate of the update transistor 312, the data signal is loaded on the gate of the update transistor 312.

Subsequently, data signals are then provided and applied to the other display data lines connected to the other display elements 300 in the first row. After all of the data for the first row is loaded, a low value of the scan voltage V_{Scan} is applied to the scan line connected to the first row. Subsequently, a high value of the scan voltage V_{Scan} is then applied to the next row (the second row in progressive scan implementations or the third row in interlaced scan implementations). The data signals for the next row are then applied to the display elements 300 within the next row. This data loading sequence proceeds sequentially throughout the array of display elements 300 until the data signal for the last display element 302 of the last row has been loaded at time t₃.

In some implementations, during the data loading sequence 402 for the current bit plane, the LEDs for the previous bit plane remain on; that is, the data loading sequence 402 for the current bit plane coincides or overlaps with the display sequence 404 for the previous bit line. In some implementations, it is desirable to keep the update transistor 312 off (non-conducting) during the data loading sequence 402 so that the current data being loaded does not charge or discharge the first node 308 or otherwise affect the display of the data for the previous bit plane. In some implementations, to keep the update transistor 312 off even when the loaded data is high (in the case of n-channel transistor; low in the case of a p-channel transistor), the source of the update transistor 312 is electrically connected to the update line carrying the update voltage V_{Upd} as opposed to, for example, an electrical ground. In some implementations, the update voltage V_{Upd} can have one of two values: a high value (which can be adjusted as described herein) configured to cause the update transistor 312 to remain in a non-conducting electrical state (an “off” state) regardless of the value of the data signal V_{Data} applied to the gate of the update transistor 312, and a low value configured to cause the update transistor 312 to switch to a conducting state (an “on” state) when the data signal V_{Data} applied to the gate of the update transistor 312 is high. In this way, the display driver can maintain the update transistor 312 in the off state by ensuring that the gate-source voltage V_{GS} is less than the threshold voltage V_{T} of the update transistor 312; that is, V_{G}−V_{S}<V_{T}. Because the gate voltage V_{G} is determined by the data signal V_{Data} provided to the corresponding data line, the display driver ensures that V_{GS} is less than V_{T} during the data loading sequence by providing an update voltage V_{Upd} to the source of the update transistor 312 that is greater than V_{G}−V_{T}.

In block 506—time t₄—the display driver provides a high voltage value of an enable voltage V_{En} to the enable lines connected to all of the display elements 300 of the array. The enable voltage V_{En} is applied to the sources of the enable transistors 314. In some implementations, the enable voltage V_{En} can have one of two values: the high value, configured to cause the enable transistor 314 to remain in an off state regardless of the voltage applied to the gate of the enable transistor 314, and a low value, configured such that the enable transistor 314 switches to an on state when the gate of the enable transistor 314 is high.

In block 508—time t₅—the display driver provides a high voltage value of a pre-charge voltage V_{Pre} to the pre-charge lines connected to all of the display elements 300 of the array. The pre-charge voltage V_{Pre} is applied to the gates of the first and second pre-charge transistors 316 and 318. In some implementations, the pre-charge voltage V_{Pre} can have one of two values: the high value, configured to cause the pre-charge transistors 316 and 318 to switch to an on state to conduct current from the actuate line to the first and the second nodes 308 and 310, respectively, and a low value, to switch the pre-charge transistors 316 and 318 to an off state. When the pre-charge transistors 316 and 318 are switched to an on state, both of the first and the second nodes 308 and 310 are charged to the actuate voltage V_{Act} on the actuate line. In this way, the actual voltage(s) applied to the first and the second terminals 304 and 306 of the light modulators 302 can be higher, and even much higher (for example, approximately 35 V in one implementation), than the voltage provided by the data signal V_{Data} (for example, approximately 5 V in one implementation).

In block 510—time t₆—the display driver provides the low value of the pre-charge voltage V_{Pre} to the pre-charge lines connected to all of the display elements 300 of the array. As a result, the first and second pre-charge transistors 316 and 318 are switched to an off state and the first and the second nodes 308 and 310 become isolated from the actuate line and left floating at the actuate voltage V_{Act}.

In block 512—time t₇—the display driver provides the low value of the update voltage V_{Upd} (for example, approximately −0.5 V in one implementation) to the update lines connected to all of the display elements 300 of the array. Now that the source of the update transistor 312 is low, the data signal V_{Data} (the voltage on the gate of the update transistor 312) will control the configuration of the light modulator 302. More specifically, if the data signal V_{Data} is high, the update transistor 312 will switch to an on state resulting in a current I_{Upd} through the update transistor 312 that discharges the first node 308 down to the current low value of the update voltage V_{Upd}. On the other hand, if the value of the data signal V_{Data} is low, the update transistor 312 will remain in an off state. Because the update transistor 312 is in an off state when the data signal V_{Data} is low, the first node 308 will remain at the high actuate voltage V_{Act}. Because the gate of the enable transistor 314 is connected to the first node 312, the gate of the enable transistor 314 will be high (at the high value of the actuate voltage V_{Act}) when the value of the data signal V_{Data} is low. Conversely, the gate of the enable transistor 314 will be low (at the low value of the update voltage V_{Upd}) when the value of the data signal V_{Data} is high.

In block 514—time t₈—the display driver provides the low value of the enable voltage V_{En} to the enable lines connected to all of the display elements 300 of the array. Now that the source of each enable transistor 314 is low, the voltage on the gate of the enable transistor 314 (which is based on the voltage on the first node 308 which, in turn, is based on the value of the data signal V_{Data}) controls the discharge of the second node 310. More specifically, if the voltage on the gate of the enable transistor 314 is high (because the first node 308 was not discharged as a result of a low data signal V_{Data} applied to the gate of the update transistor 312), the enable transistor 314 will switch to an on state resulting in a current I_{En} through the enable transistor 314 that discharges the second node 310 down to the current low value of the enable voltage V_{Upd}. On the other hand, if the voltage on the gate of the enable transistor 314 is low (because the first node 308 was discharged as a result of a high data signal V_{Data} applied to the gate of the update transistor 312), the enable transistor 314 will remain in an off state and the second node 310 will remain charged at the high value of the actuate voltage V_{Act}.

In block 516—time t₉—the display driver provides the high value of the update voltage V_{Upd} to the update lines connected to all of the display elements 300 of the array. Now that the source of the update transistor 314 is high, the update transistor 314 will switch or remain in an off state and, as a result, will electrically isolate the first and the second nodes 308 and 310 from the new data for the next bit plane. This marks the end of the display sequence 404. As described above, the timing sequence 400 and the process flow 500 can be repeated for each bit plane update.

As is evident from the above description, during normal (or ideal) operation, one of the first and the second nodes 308 and 310 is low (discharged) at any given time; the other one of the first and the second nodes 308 or 310 is low (charged to the actuate voltage V_{Act}). In this way, the first and the second nodes 308 and 310 are complementary nodes. In some shutter-based implementations, whichever one of the first and the second nodes 308 and 310 is high causes the respective actuator to pull the shutter towards the respective node.

In some implementations, proper operation of each update transistor 312, and the corresponding light modulator 302, is achieved when a ratio of the current I_{Upd} through the first node 308 (and through the update transistor 312) to the current I_{En} through the second node 310 (and through the enable transistor 314) is equal to a ratio of the capacitance C_{Upd} of the first node 308 (which includes the capacitance of the update transistor 312) to the capacitance C_{En} of the second node 310 (which includes the capacitance of the enable transistor 314). The values of C_{Upd} and C_{En} are functions of various properties associated with the first and second nodes 308 and 310, including properties of the update and enable transistors 312 and 314 (for example, the widths and lengths of the gates as well as the dielectric materials used to insulate the gates from the respective semiconductor thin-films). Thus, the values of C_{Upd} and C_{En} are effectively static and known, and consequently, proper operation is achieved when the following base equation is satisfied (at least within a suitable tolerance):

$${I}_{Upd} = {I}_{En} * \frac{{C}_{Upd}}{{C}_{En}} \qquad ( Equation 1 )$$

As described above, various implementations relate to a compensation circuit capable of adjusting, or causing an adjustment to, a biasing voltage applied to a transistor. In some display implementations, such a compensation circuit can be integrated with a display driver and connected with an associated array of display elements. However, in some other implementations, such a compensation circuit as described herein can be integrated with other electrical elements in non-display contexts. The following description describes implementations in which the compensation circuit receives input from an entire array of display elements and causes an adjustment to an update voltage applied globally to the entire array of display elements responsive to the received input. However, in some other implementations, a compensation circuit as described herein can receive input from one transistor and cause an adjustment to an update voltage applied to an entire array of transistors, which may or may not include the transistor from which the input was received. In some other implementations, a compensation circuit as described herein can receive input from one transistor and cause an adjustment to an update voltage applied to the same transistor. In some other implementations, a compensation circuit as described herein can receive input from one transistor and cause an adjustment to an update voltage applied to a different transistor.

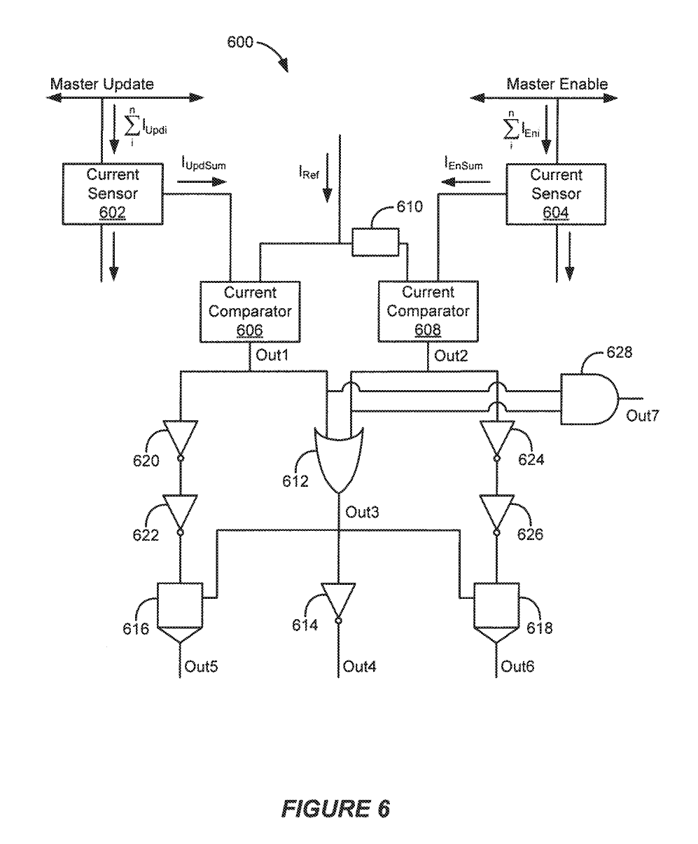

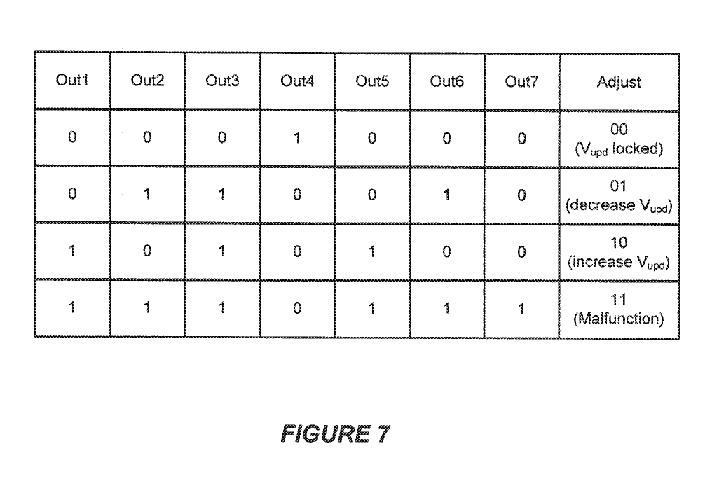

FIG. 6 shows a schematic diagram of an example compensation circuit 600. For example, the compensation circuit 600 can be used to adjust the global update voltage V_{Upd} for the update transistors 312 in the display elements 300 described with reference to FIG. 3. FIG. 7 shows an example truth table that can be obtained using the example compensation circuit of FIG. 6. The compensation circuit 600 includes a first current sensor 602 that is electrically connected to (or with) a master update line that is connected with all of the update lines of the array of display elements 300. As such, the master update line receives the sum of the currents I_{Upd} through each of the update transistors 312. Thus, the current I_{UpdSum} sensed by the first current sensor 602 can be expressed as

I_{UpdSum}=Σ₁ⁿI_{Updi}, (Equation 2)

where n represents the number of display elements 300 in the array.

Similarly, the second current sensor 604 is electrically connected to (or with) a master enable line that is connected with all of the enable lines of the array of display elements 300. As such, the master enable line receives the sum of the currents I_{En} through each of the enable transistors 314. Thus, the current I_{EnSum} sensed by the second current sensor 604 can be expressed as

I_{EnSum}=Σ₁ⁿI_{Eni}. (Equation 3)

The first current comparator 606 compares the sensed current I_{UpdSum} to a reference current I_{Ref}, for example, received from the display driver. In some implementations, because the charge carriers that constitute the currents I_{Upd} and I_{En} originate from the actuate line, the reference current I_{Ref} can advantageously have a current value proportional or equal to the current I_{Act} through the actuate line. The output of the first current comparator 606 is a first output signal Out1. For example, if I_{UpdSum}>I_{Ref}, the first current comparator 606 outputs a high value of Out1 (Out1=1). Conversely, if I_{UpdSum}<I_{Ref}, the first current comparator 606 outputs a low value of Out1 (Out1=0).

In some implementations or applications, the capacitance C_{Upd} is not equal to the capacitance C_{En}. In some such implementations, the second current comparator 608 can compare the current I_{EnSum} to a different reference current than that used for the comparison of the current I_{UpdSum}. For example, the second current comparator 608 can compare the current I_{EnSum} to a second reference current equal to

$$\frac{{C}_{Upd}}{{C}_{En}} * {I}_{Ref}$$

to compensate for the differences in the capacitances and to satisfy the Equation 1. For example, the compensation circuit 600 can include a multiplier 610 that receives the reference current I_{Ref} and that generates a second reference current equal to the product of the reference current I_{Ref} and a multiplication value equal to the ratio

$$\frac{{C}_{Upd}}{{C}_{En}} .$$

The output of the second current comparator 608 is a second output signal Out2. For example, if

$${I}_{EnSum} > \frac{{C}_{Upd}}{{C}_{En}} * {I}_{Ref} ,$$

the second current comparator 608 outputs a high value of Out2 (Out2=1). Conversely, if

$${I}_{EnSum} < \frac{{C}_{Upd}}{{C}_{En}} * {I}_{Ref} ,$$

the second current comparator 608 outputs a low value of Out2 (Out2=0).

In some other implementations or applications, the capacitance C_{Upd} can be equal to the capacitance C_{En}. In such implementations, a multiplier such as the multiplier 610 may not be included in the compensation circuit. In some such implementations, the second current comparator 608 compares the sensed current I_{EnSum} directly to the reference current I_{Ref}. In some other implementations, rather than using a multiplier such as multiplier 610 to generate a second reference current, the multiplier can be used to multiply the current I_{EnSum} by the ratio c_{Upd}/c_{En}. In yet other implementations, both of the currents I_{UpdSum} and I_{EnSum} can be provided to a multiplier or other logical element for multiplying (or otherwise modifying) the respective currents by the same or different values. For example, it may be desirable to increase both of the currents I_{UpdSum} and I_{EnSum} or to decrease both of the currents I_{UpdSum} and I_{EnSum}. Additionally, in some implementations the reference current I_{Ref} can be adjusted to introduce a threshold or tolerance into one or more of the comparisons. For example, in some implementations in which the reference current I_{Ref} has a value based on the current I_{Act} through the actuate line, an offset can be introduced in the value of the reference current I_{Ref} relative to the current I_{Act} through the actuate line to introduce a threshold or tolerance into the comparisons of I_{UpdSum} and I_{EnSum} described above.

The compensation circuit 600 further includes a number of logic gates. For example, the outputs Out1 and Out2 of the first current comparator 606 and the second current comparator 608 can be provided to an OR gate 612, the output of which is an output signal Out3. For example, when both the output signals Out1 and Out2 are low (0), the value of Out3 is low (0). This means that both of the currents I_{UpdSum} and I_{EnSum} are within a normal or suitable operating range and consequently, that the update voltage V_{Upd} does not need adjusting. In some implementations, the output signal Out3 is provided to an inverter 614 that inverts the output signal Out3 to provide an inverted output signal Out4 having the opposite value of the output signal Out3.

In some implementations, the output signal Out3 also is routed to a first function generator 616 and a second function generator 618. In some such implementations, the output signal Out3 is used as an enable voltage for enabling the first and the second function generators 616 and 618 when the value of the output signal Out3 is high. The first function generator 616 also receives the output signal Out1. Similarly, the second function generator receives the output signal Out2. In the illustrated implementations, the output signal Out1 is first passed to a pair of inverters 620 and 622 while the output signal Out 2 is first passed to a pair of inverters 624 and 626. For example, in some implementations or applicants, the output signals Out1 and Out2 are relatively week signals. The inverters 620, 622, 624 and 626 can be used as buffers and to provide stronger signal strength copies of the values of the respective output signals Out1 and Out2 to ensure proper accuracy and operation.

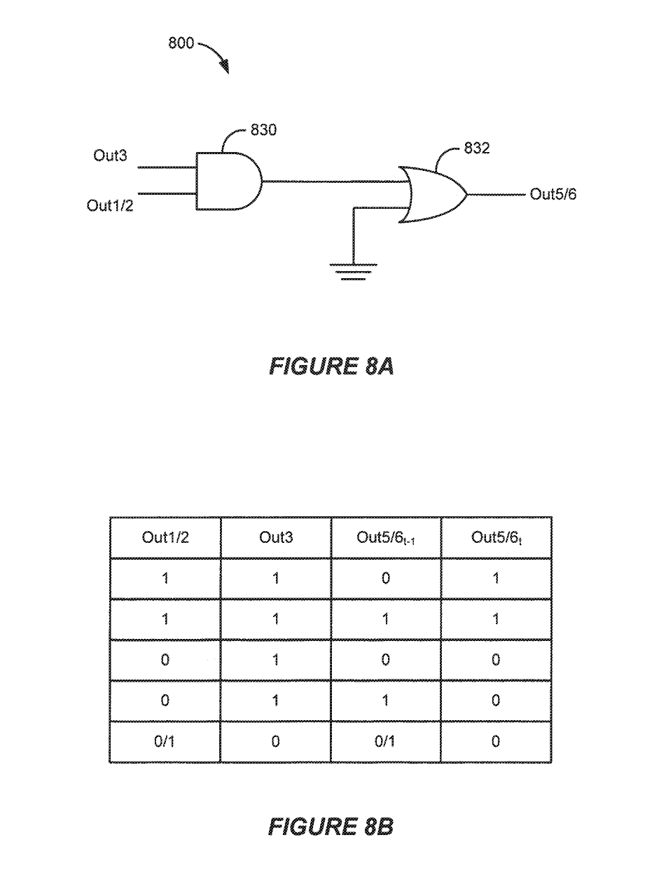

FIG. 8A shows an example of a function generator 800. In some implementations, each of the function generators 616 and 618 shown and described with reference to FIG. 6 can be implemented by a respective function generator 800 as shown in FIG. 8A. For example, the compensation circuit 600 of FIG. 6 can include two of the function generators 800 of FIG. 8A, one for implementing the function generator 616 and one for implementing the function generator 618. The function generator 800 includes an AND gate 830 and an OR gate 832. The AND gate 830 of the function generator 800 includes a first input that receives the output signal Out3 and a second input that receives the respective one of the output signals Out1 and Out2 depending on whether the function generator 800 is implementing the function generator 616 or the function generator 618. The output of the AND gate 830 is passed to a first input of the OR gate 832. A second input of the OR gate 832 can be coupled with a ground or other reference voltage. When enabled by a high output signal Out3, the AND gate 830 of the first function generator 616 passes the output signal Out1 to the respective OR gate 832. Similarly, when enabled by a high output signal Out3, the AND gate 830 of the second function generator 618 passes the output signal Out2 to the respective OR gate 832. The output of the OR gate 832 is the output signal of the function generator 800: the output signal Out5 in this case of the function generator 616 and the output signal Out6 in the case of the function generator 618. FIG. 8B shows an example truth table that can be obtained using the example function generator 800 of FIG. 8A (the subscript “t” indicates the current output value while the subscript “t−1” indicates the previous output value).

Referring back to FIG. 6, when the current I_{UpdSum} is greater than the first reference current I_{Ref}, the first function generator 616 outputs an output signal Out5 having a high value (Out5=1). A high value of the output signal Out5 indicates that the current I_{UpdSum} exceeds the suitable operating range, and thus, that the display driver should increase the update voltage V_{Upd} (for example, by increasing the update voltage by an incremental amount). Similarly, when the current I_{EnSum} is greater than the reference current I_{Ref} (or a second reference current

$$\frac{{C}_{Upd}}{{C}_{En}} * {I}_{Ref} ) ,$$

the second function generator 618 outputs an output signal Out6 having a high value (Out6=1). A high value of the output signal Out6 indicates that the current I_{EnSum} exceeds the suitable operating range, and thus, that the display driver should decrease the update voltage V_{Upd} (for example, by decreasing the update voltage by an incremental amount).

The compensation circuit 600 also can include an AND gate 628 that receives the output signals Out1 and Out2 and provides an output signal Out7. In some such implementations, when the currents I_{UpdSum} and I_{EnSum} are both greater than the respective reference currents, and thus both output signals OUT1 and OUT2 are high, the AND gate 628 outputs an output signal Out7 having a high value (Out7=1). A high value of the output signal Out7 indicates that both of the currents I_{UpdSum} and I_{EnSum} exceed the suitable operating range. For example, this can result when there is a general leakage problem with the display. Thus, the output signal Out7 can be used as a control signal indicating a malfunction or error condition.

In some implementations, the output signals Out4, Out5 and Out6 (and in some implementations the output signal Out7) are used as adjustment signals that are subsequently provided to the display driver and used by the display driver to adjust the update voltage V_{Upd} up or down or to lock in (maintain the value of) the current update voltage V_{Upd}. In some other implementations, the outputs Out4, Out5, Out6 are used as control signals that are communicated to another logic device or circuit element to generate a two-bit adjustment signal, Adjust (shown in the truth table of FIG. 7).

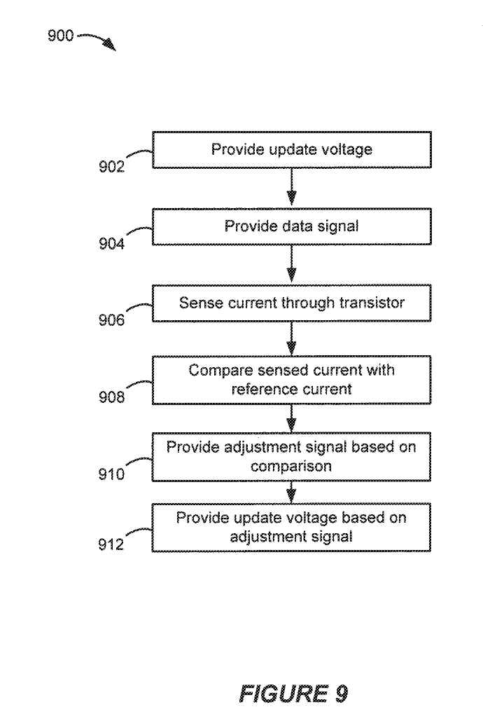

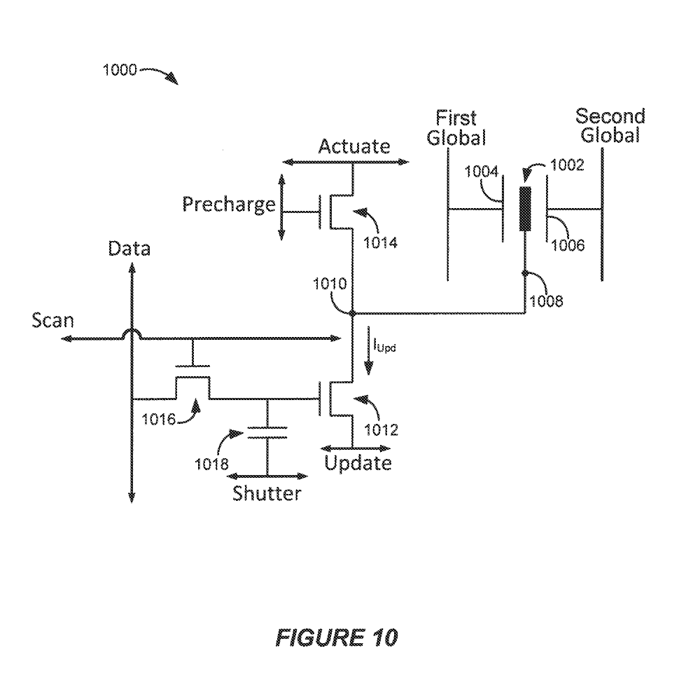

FIG. 9 shows a flowchart of an example process flow 900 for adjusting a voltage. For example, the process flow 900 can be implemented using the compensation circuit 600 of FIG. 6 and, in some implementations, in conjunction with a display driver. For example, the process flow 900 can be used to adjust the update voltage V_{Upd} provided to the five-transistor display elements 300 of FIG. 3 or to the three-transistor display elements 1000 described below with reference to FIG. 10. In some other implementations, the process flow can be used to adjust a biasing voltage applied to a transistor or other circuit element in non-display applications.

In some implementations, the process flow 900 begins in block 902 with providing an update voltage to a transistor electrically connected with a terminal of an electrical element. In block 904, a data signal is provided to the transistor. In block 906, a current through the transistor is sensed. In some more specific implementations, the sensed current includes or is proportional to a current contribution through the transistor. Subsequently, in block 908, the sensed current is compared with a reference current. In block 910, at least one adjustment signal is provided based on the comparison. An update voltage can then be adjusted (or locked in) in block 912 based on the adjustment signal.

In some implementations, the process flow 900 can be performed periodically. For example, when the process flow 900 is used in conjunction with a display, such as with the display elements 300 or 1000 of FIGS. 3 and 10, the process flow 900 can be performed with each bit plane update. For example, the process flow 900 can be performed prior to each data loading sequence 400, for example, just before the process flow 500. In some such implementations, prior to providing the update voltage to the transistors in block 902, a driver circuit provides a high value of the update voltage to the transistors in a first half of the display elements of an associated array and a low update voltage to the transistors in a second half of the display elements of the array. In the context of the display element 300 of FIG. 3, by applying a high update voltage to the first half and a low update voltage to the second half, the first nodes 308 in the first half should be discharging while the second nodes 310 in the first half remain charged (for example, at the actuate voltage). Similarly, the second nodes 310 in the second half should be discharging while the first nodes 308 in the second half should remain charged.

FIG. 10 shows a schematic diagram of an example display element 1000 that includes three transistors. The display element 1000 includes a light modulator 1002 having a first terminal 1004 and a second terminal 1006. The first terminal 1004 can be electrically connected with a first global line while the second terminal 1006 can be electrically connected to a second global line. The light modulator 1002 also has a third terminal 1008 electrically connected to the light modulator 1002 itself, for example, to a shutter as described with reference to FIGS. 2A and 2B. The third terminal 1008 is electrically connected to a node 1010. Unlike in the display element 300 of FIG. 3 in which the light modulator 302 changes configuration responsive to driving voltages applied to the first and the second terminals 304 and 308 on either side of the light modulator 302, in the display element 1000 of FIG. 10, the light modulator 1002 changes configuration responsive to a driving voltage applied to a third terminal 1008 electrically connected to the light modulator itself, for example, to the shutter itself. For example, the first global line can have a high (or positive) voltage while the second global line can have a low voltage (a negative or less positive voltage). In this way, the shutter can be pulled toward the first terminal 1004 (for example, to allow light to pass) by applying a low voltage to the third terminal 1006, while the shutter can be pulled toward the second terminal 1006 (for example, to block light) by applying a high voltage to the third terminal 1006.

The display element 1000 includes a first transistor 1012 (also referred to as the update transistor) having a gate, a drain and a source. The drain of the update transistor 1012 is electrically connected to the third terminal 1006 via the node 1010. The source of the update transistor 1012 is electrically connected to an update line capable of carrying and providing an update voltage V_{Upd} to the source. The display element 1000 includes a second transistor 1014 (also referred to as the pre-charge transistor) having a gate, a drain and a source. The drain of the pre-charge transistor 1014 is electrically connected to the third terminal 1006 via the first node 1010. The source of the pre-charge transistor 1014 is electrically connected to an actuate line capable of carrying and providing an actuate voltage V_{Act}. The gate of the pre-charge transistor 1014 electrically connected to a pre-charge line capable of carrying and providing a pre-charge voltage V_{Pre}.

The display element 1000 further includes a third transistor 1016 (also referred to as the data load transistor) and a capacitor 1018. The source of the third transistor 1016 is electrically connected to a corresponding data line capable of carrying and providing a data signal V_{Data} for the display element. The gate of the third transistor 1016 is electrically connected to a corresponding scan line capable of carrying and providing a scan voltage V_{Scan}. The drain of the third transistor 1016 is electrically connected to the gate of the update transistor 1012 and to a terminal of the capacitor 1018. The other terminal of the capacitor 1018 is electrically connected to a reference line capable of carrying and providing a shutter voltage V_{Shut}.

Some or all of the electrical voltages or electrical currents described herein can be considered electrical signals, regardless of whether such signals are provided, applied, detected, sensed, measured or determined, and regardless of whether such signals are static or time-varying signals. Some signals described herein are binary signals capable of having one of two possible states. For example, such binary signals can have a first (or high) value and a second (or low) value. However, no limitation is inherent or suggested by way of referring to a signal as high or low. On the contrary, such high and low labels are intended to facilitate the description of the disclosed implementations, and not to define an operating range of the associated signal. Additionally, such high and low labels as described in the context of one type of transistor (for example, an n-type transistor) can be reversed in the context of a second type of transistor (for example, a p-type transistor). The signals described herein can be carried, provided or received via corresponding signal lines. The term “line” also is used interchangeably herein with interconnect, trace, wire and link, where appropriate.

FIGS. 11A and 11B show system block diagrams of an example display device 40 that includes a plurality of display elements. For example, the display elements can be MEMS-based display elements such as the shutter-based display elements described above. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 11B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 11A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, the conjunction “or” is intended herein in the inclusive sense where appropriate unless otherwise indicated; that is, the phrase “A, B or C” is intended to include the possibilities of A, B, C, A and B, B and C, A and C and A, B and C. Additionally, a phrase referring to “at least one of” a list of items refers to any combination of those items, including single members. As an example, “at least one of: A, B, or C” is intended to cover: A, B, C, A-B, A-C, B-C, and A-B-C.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A system comprising:
a display including at least one array of display elements, each display element including an electrical element having a first terminal and a first transistor electrically coupled with the first terminal, each electrical element capable of at least a first configuration and a second configuration based on an electrical state of the first transistor;
a first current sensor capable of sensing a first current through at least one of the first transistors in the array of display elements;
a compensation circuit capable of comparing the first current with a first reference current and providing at least one adjustment signal based on the comparison;
a display driver capable of:
providing an update voltage based on the at least one adjustment signal, and
providing a data signal for each of the display elements;
the electrical state of each of the first transistors being based on the update voltage and the data signal.

2. The system of claim 1, wherein each electrical element includes:
a microelectromechanical systems (MEMS)-based light modulator; and
at least one actuator electrically coupled with the first terminal and capable of causing the MEMS-based light modulator to transition among the first configuration and the second configuration.

3. The system of claim 1, wherein the first current is equal to or proportional to a combined sum of the currents through the first transistors of the array of display elements.

4. The system of claim 1, wherein:
when the first current is greater than the first reference current, the compensation circuit provides a first value of the at least one adjustment signal configured to cause an increase in the update voltage; and
when the first current is approximately equal to the first reference current, the compensation circuit provides a second value of the at least one adjustment signal configured to cause the value of the update voltage to be maintained.

5. The system of claim 4, wherein:
each electrical element further includes a second terminal;
each display element further includes a second transistor electrically coupled with the second terminal;
the system further includes a second current sensor capable of sensing a second current through at least one of the second transistors; and
the compensation circuit is further capable of comparing the second current with a second reference current and providing the at least one adjustment signal based on the comparison.

6. The system of claim 5, wherein:
when the second current is greater than the second reference current, the compensation circuit provides a third value of the at least one adjustment signal configured to cause a decrease in the voltage of the update voltage; and
when the first current is approximately equal to the first reference current and the second current is approximately equal to the second reference current, the compensation circuit provides the second value of the at least one adjustment signal.

7. The system of claim 6, wherein when the first current is greater than the first reference current and the second current is greater than the second reference current, the compensation circuit provides a fourth value of the at least one adjustment signal configured to cause an indication of an error condition.

8. The system of claim 5, further including a multiplier for multiplying the first reference current by a multiplication value to generate the second reference current, the multiplication value being proportional to a ratio of a capacitance of the first transistor to a capacitance of the second transistor.

9. The system of claim 5, wherein the second current is equal to or proportional to a combined sum of the currents through the second transistors of the array of display elements.

10. The system of claim 5, wherein each electrical element further includes at least one actuator electrically coupled with the second terminal of the electrical element and capable of causing the electrical element to transition among the first configuration and the second configuration.

11. The system of claim 10, wherein:
the display driver is further capable of providing an enable voltage;
the system further includes a plurality of enable lines each configured to communicate the enable voltage to the display elements; and
each of the second transistors of the array of display elements includes a gate terminal electrically coupled with the first terminal of the electrical element, a second terminal electrically coupled with a corresponding one of the enable lines for receiving the enable voltage, and a third terminal electrically coupled with the second terminal of the electrical element.

12. The system of claim 1, wherein the display driver is further capable of providing a write-enable signal, the system further including:
a plurality of scan lines each configured to communicate the write-enable signal to a respective row of the display elements;
a plurality of data lines each configured to communicate the data signal to a respective column of the display elements; and
a plurality of update lines each configured to communicate the update voltage to the display elements.

13. The system of claim 12, wherein each of the first transistors includes:
a gate terminal electrically coupled with a corresponding one of the data lines for receiving the corresponding data signal;
a second terminal electrically coupled with a corresponding one of the update lines for receiving the update voltage; and
a third terminal electrically coupled with the first terminal of the electrical element.

14. The system of claim 13, wherein:
the display driver is further capable of providing a pre-charge voltage and a supply voltage;
the system further includes:
a plurality of pre-charge lines each configured to communicate the pre-charge voltage to the display elements, and
a plurality of supply lines each configured to communicate the supply voltage to the display elements; and
each display element further includes:
a third transistor having a gate terminal electrically coupled with a corresponding one of the pre-charge lines for receiving the pre-charge voltage, a second terminal electrically coupled with a corresponding one of the supply lines for receiving the supply voltage, and a third terminal electrically coupled with the first terminal of the electrical element, and
a fourth transistor having a gate terminal electrically coupled with a corresponding one of the scan lines for receiving the write-enable signal, a second terminal electrically coupled with the corresponding one of the data lines for receiving the corresponding data signal, and a third terminal electrically coupled with the gate terminal of the first transistor for communicating the data signal to the gate terminal of the first transistor.

15. The system of claim 1, further including:
a processor capable of communicating with the display, the processor being capable of processing image data;
a memory device capable of communicating with the processor; and
a controller capable of sending at least a portion of the image data to the display driver.

16. The system of claim 15, wherein:
the controller sends the image data to the display driver in a series of image frames;
each image frame includes at least one bit-plane; and
the compensation circuit performs the comparing for each bit-plane in each image frame.

17. The system of claim 15, further including an image source module capable of sending the image data to the processor, wherein the image source module includes at least one of a receiver, transceiver, and transmitter.

18. The system of claim 15, further including an input device capable of receiving input data and communicating the input data to the processor.

19. A display apparatus comprising:
a first transistor capable of receiving a data signal and an update voltage, an electrical state of the first transistor being based on the data signal and the update voltage;
an electrical element having a first terminal electrically coupled with the first transistor, the electrical element capable of at least a first configuration and a second configuration based on the electrical state of the first transistor;
a first current sensor capable of sensing a first current through the first transistor;
a compensation circuit capable of comparing the first current with a first reference current and providing at least one adjustment signal based on the comparison; and
a driver circuit capable of providing the update voltage for the first transistor based on the at least one adjustment signal.

20. The display apparatus of claim 19, wherein:
when the first current is greater than the first reference current, the compensation circuit provides a first value of the at least one adjustment signal configured to cause an increase in the update voltage; and
when the first current is approximately equal to the first reference current, the compensation circuit provides a second value of the at least one adjustment signal configured to cause the value of the update voltage to be maintained.

21. The display apparatus of claim 20, wherein:
the electrical element further includes a second terminal;
the apparatus further includes:
a second transistor electrically coupled with the second terminal, and
a second current sensor capable of sensing a second current through the second transistor; and
the compensation circuit is further capable of comparing the second current with a second reference current and providing the at least one adjustment signal based on the comparison.

22. The display apparatus of claim 21, wherein:
when the second current is greater than the second reference current, the compensation circuit provides a third value of the at least one adjustment signal configured to cause a decrease in the voltage of the update voltage; and
when the first current is approximately equal to the first reference current and the second current is approximately equal to the second reference current, the compensation circuit provides the second value of the at least one adjustment signal.

23. The display apparatus of claim 22, wherein when the first current is greater than the first reference current and the second current is greater than the second reference current, the compensation circuit provides a fourth value of the at least one adjustment signal configured to cause an indication of an error condition.

24. The display apparatus of claim 19, wherein the electrical element is capable of displaying light based on the first configuration and the second configuration.

25. An apparatus comprising:
first switching means for receiving a data signal and an update voltage, an electrical state of the first switching means being based on the data signal and the update voltage;
electrical means having a first terminal electrically coupled with the first switching means, the electrical means capable of at least a first configuration and a second configuration based on the electrical state of the first switching means;
first current sensing means for sensing a first current through the first switching means;
compensation means for comparing the first current with a first reference current and providing at least one adjustment signal based on the comparison; and
driving means for providing the update voltage for the first switching means based on the at least one adjustment signal.

26. The apparatus of claim 25, wherein:
when the first current is greater than the first reference current, the compensation means provides a first value of the at least one adjustment signal configured to cause an increase in the update voltage; and
when the first current is approximately equal to the first reference current, the compensation means provides a second value of the at least one adjustment signal configured to cause the value of the update voltage to be maintained.

27. The apparatus of claim 26, wherein:
the electrical means further includes a second terminal;
the apparatus further includes:
second switching means electrically coupled with the second terminal of the electrical means, and
second current sensing means for sensing a second current through the second switching means; and
the compensation means is further for comparing the second current with a second reference current and providing the at least one adjustment signal based on the comparison.

28. The apparatus of claim 27, wherein:
when the second current is greater than the second reference current, the compensation means provides a third value of the at least one adjustment signal configured to cause a decrease in the voltage of the update voltage; and
when the first current is approximately equal to the first reference current and the second current is approximately equal to the second reference current, the compensation means provides the second value of the at least one adjustment signal.

29. The apparatus of claim 28, wherein when the first current is greater than the first reference current and the second current is greater than the second reference current, the compensation means provides a fourth value of the at least one adjustment signal configured to cause an indication of an error condition.
